(19) United States
(12) Patent Application Publication
(10) Pub. No.: US 2011/0150550 A1
(43) Pub. Date: Jun. 23, 2011

(54) SHEET POST-PROCESSING APPARATUS AND IMAGE FORMING SYSTEM

(75) Inventors: Hiroyuki WAKABAYASHI, Tokyo (JP); Tsutomu Anezaki, Tokyo (JP)

(73) Assignee: KONICA MINOLTA BUSINESS TECHNOLOGIES, INC., Tokyo (JP)

(21) Appl. No.: 12/961,747

(22) Filed: Dec. 7, 2010

(30) Foreign Application Priority Data
Dec. 18, 2009 (JP) JP2009-287401

(51) Int. Cl. G03G 15/00; B65H 39/10; B41L 43/02

(52) U.S. Cl. 399/407; 270/58.08; 270/37

(57) ABSTRACT

A sheet post-processing apparatus including, a sheet receiving section to receive sheets, a punching device to punch sheets; an accumulating section to accumulate sheets; a stitching device to stitch the sheets accumulated in the accumulating section; a sheet discharging section to which the sheets stitched by the stitching device are discharged; and a conveyance path to connect the sheet receiving section, the punching device, the accumulating section, and the sheet discharging section, wherein the conveyance path comprises an upper loop and a lower loop and has an S-shaped conveyance path to convey a sheet from the sheet receiving section to the accumulating section; and the punching device is arranged in the upper loop.

### RELATED APPLICATION

The present application is based on Patent Application No. 2009-287401 filed at the Japan Patent Office on Dec. 18, 2009 and which is hereby incorporated herein in its entirety.

### TECHNICAL FIELD

The present invention relates to a sheet post-processing apparatus having a punching device to punch filing holes in a sheet and an image forming system.

### BACKGROUND

A high-speed image forming apparatus such as an electrophotographic image forming apparatus is frequently used in combination of a sheet post-processing apparatus to carry out various kinds of post-processings for a sheet on which an image has been formed.

A number of sheet post-processing apparatuses do not have only a single processing function but have a plurality of processing functions. Especially, a punching device is frequently built in a sheet post-processing apparatus together with a stitching device to stitch sheets.

Unexamined Japanese Patent Application Publication No. 2000-72320 and Unexamined Japanese Patent Application Publication No. 2002-308521 describe a sheet post-processing apparatus having a punching device, a stitching device, and a shifting device.

### SUMMARY

A punching device and a stitching device are commonly arranged in parallel in the conveyance direction in a sheet conveyance path. Thereby, the width of a sheet post-processing apparatus, namely, the distance from the right and the left side of the sheet post-processing apparatus when viewed from the operator has a limitation in length in which the width of an accumulating section and a stitching device is added to the width of a punching device, whereby it has been difficult to reduce the width of the sheet post-processing apparatus to allow the apparatus to be compact.

In Unexamined Japanese Patent Application Publication No. 2000-72320, a post-processing apparatus is divided into two units. On unit is provided with a punching device, and the other unit is provided with a stitching device and an accumulating section.

In Unexamined Japanese Patent Application Publication No. 2002-308521, the slope of an accumulating section is allowed to be steep, namely, the angle of the accumulating section with respect to the horizon is allowed to be large.

To reduce the width of the sheet post-processing apparatus to allow the apparatus to be more compact, the slope of the accumulating section needs to be steeper.

However, when the slope of the accumulating section is allowed to be steep, it becomes difficult to maintain thin paper in the flat state in the accumulating section.

One aspects of the present invention is a sheet post-processing apparatus including, a sheet post-processing apparatus including, a sheet receiving section to receive sheets, a punching device to punch sheets; an accumulating section to accumulate sheets; a stitching device to stitch the sheets accumulated in the accumulating section; a sheet discharging section to which the sheets stitched by the stitching device are discharged; and a conveyance path to connect the sheet receiving section, the punching device, the accumulating section, and the sheet discharging section, wherein the conveyance path comprises an upper loop and a lower loop and has an S-shaped conveyance path to convey a sheet from the sheet receiving section to the accumulating section; and the punching device is arranged in the upper loop.

Another aspect of the present invention is an image forming system including; an image forming apparatus to form an image on a sheet; and the sheet post-processing apparatus of claim 1 to receive and process a sheet discharged from the image forming apparatus.

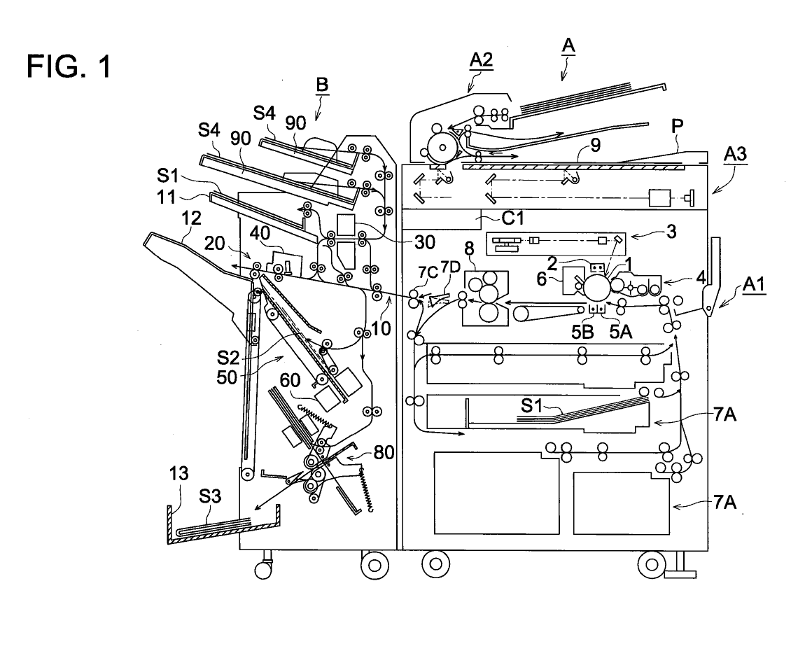

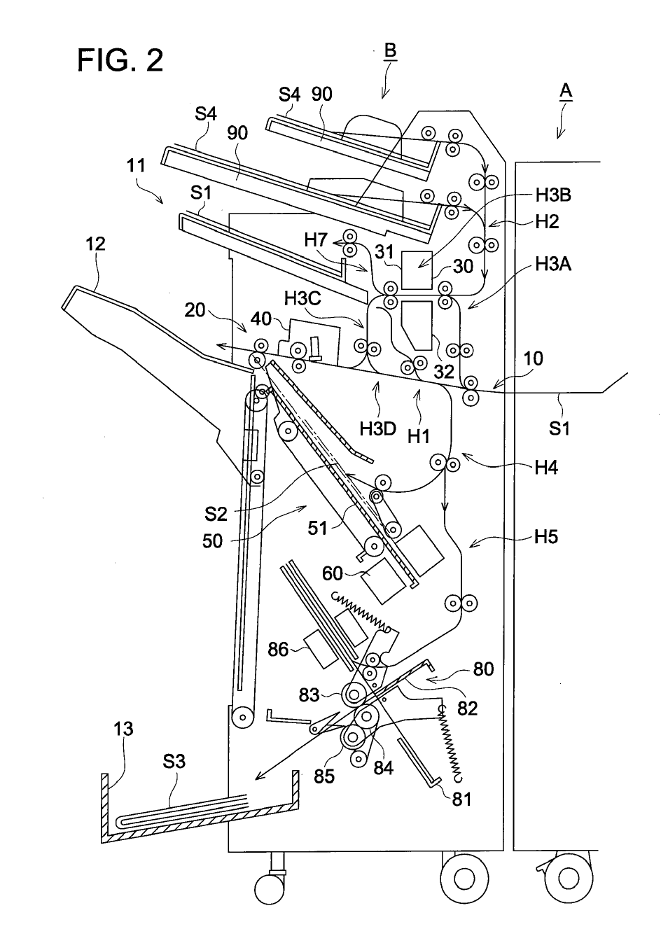

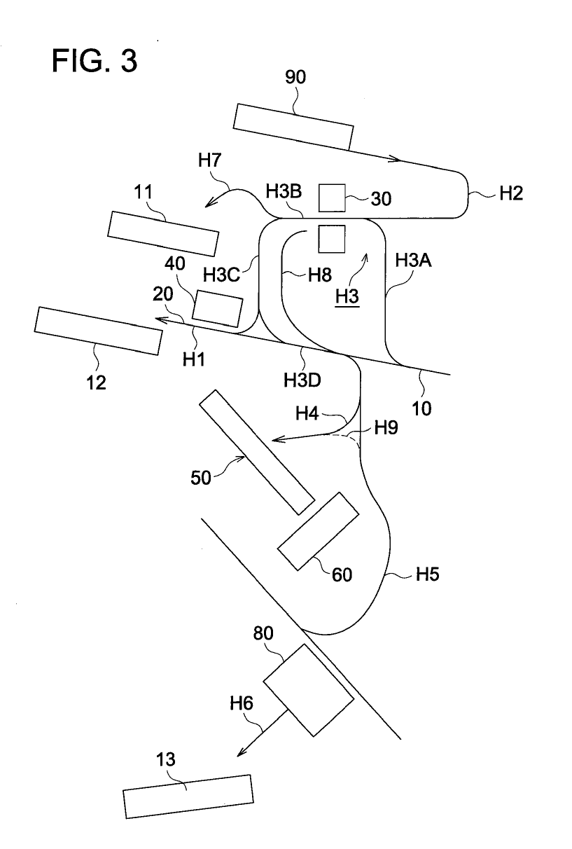

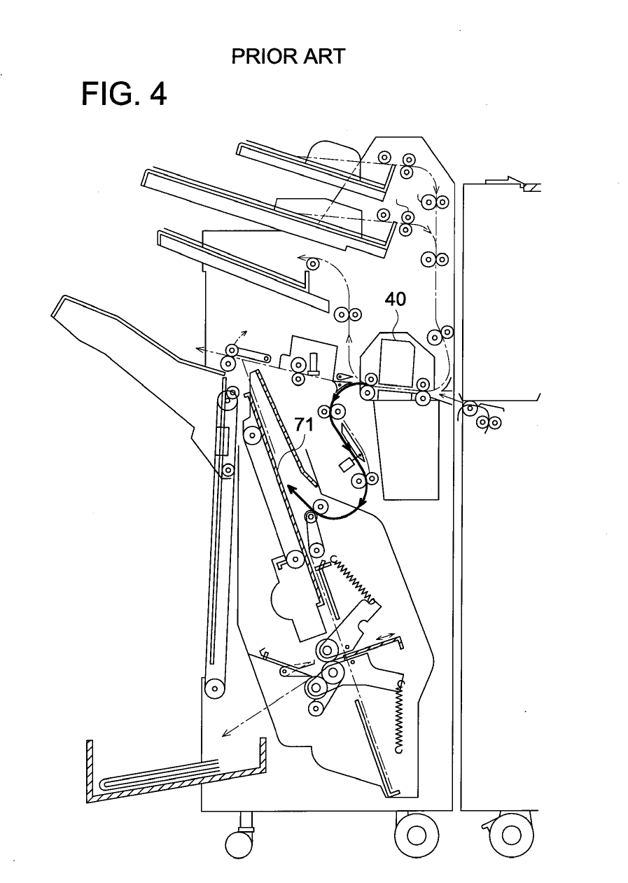

### BRIEF DESCRIPTION OF THE DRAWINGS

[FIG. 1] A view showing an entire image forming system provided with an image forming apparatus A and a sheet post-processing apparatus B.

[FIG. 2] A view showing the constitution of the sheet post-processing apparatus B.

[FIG. 3] A view showing conveyance paths in the sheet post-processing apparatus B.

[FIG. 4] A view showing the sheet post-processing apparatus described in Unexamined Japanese Patent Application Publication No. 2002-308521.

### DESCRIPTION OF THE PREFERRED EMBODIMENTS

The present invention will now be described with reference to the embodiments shown that by no means limit the scope of the present invention.

### <Image Forming System>

FIG. 1 is a view showing an entire image forming system provided with an image forming apparatus A and a sheet post-processing apparatus B.

The image forming system A forms an image on a sheet via an electrophotographic system, and has an image forming section A1, a document conveyance device A2, and an image reading section A3.

In the image forming section A1, in the periphery of a drum-shaped photoreceptor 1, a charging device 2, an exposure device 3, a developing device 4, a transfer device 5A, a separating device 5B, and a cleaning device 6 are arranged. By these electrophotographic process devices, charging, exposure, development, and transfer are carried out and then a toner image is formed on the photoreceptor 1 to form an image on a sheet S1.

Sheets S1 are stored in sheet feed trays 7A. From these sheet feed trays 7A, a sheet S1 is fed at a time. A toner image on the photoreceptor 1 is transferred onto the sheet S1 by the transfer device 5A.

The sheet S1 on which the toner image has been transferred is passed through a fixing device 8 and subjected to fixing processing. The sheet S1 having been subjected to fixing processing is discharged from a sheet discharging roller 7C or conveyed to a sheet re-feed path 7E.

In face-down sheet discharging in single-sided printing, face-up sheet discharging in single-sided printing, or front surface image formation in double-sided printing, a switching gate 7C switches and guides a sheet S1. Namely, in the face-up sheet discharging, the switching gate 7D allows the sheet S1 to move straight, and in the face-down sheet discharging and the double-sided image formation, the switching gate 7D guides the sheet S1 downward.

In the face-down sheet discharging, the sheet S1 is guided downward, followed by being switched back for upward conveyance to be discharged from the sheer discharging roller 7C.

In the double-sided image formation, the sheet S1 is guided downward and passed through the sheet re-feed path 7E after front/rear reversing via switch back, followed by being re-fed to a transfer section, in which the transfer device 5A is arranged, to transfer a rear surface image.

The document conveyance device 2A conveys original documents to the reading position sheet by sheet. The image reading section A3 reads the image of an original document having been conveyed from the document conveyance device A2 or of an original document having been placed on the document platen 9 to generate an image signal.

An operation panel P has a touch panel. In the touch panel, items of information on various operation switches and bookbinding processing are displayed. Then, operation information on such various operation switches is input into an image forming apparatus control member C1.

The image forming apparatus control member C1 controls the above operations with respect to the image forming apparatus A.

Various kinds of information are mutually transferred and received between a communication member (not shown) of the image forming apparatus carrying out serial communication and the sheet post-processing apparatus B.

The sheet post-processing apparatus B is an apparatus to carry out various kinds of post-processing such as punching processing and stitching processing for a sheet S1 having been fed in from the mage forming apparatus A.

### <Sheet Post-Processing Apparatus>

FIG. 2 is a view showing the constitution of the sheet post-processing apparatus B.

The sheet post-processing apparatus B has a punching device 30 to punch a sheet S1 having been discharged from the image forming apparatus A, a shifting device 40 to shift a sheet S1 at right angles of the conveyance direction, an accumulating section 50 to accumulate sheets S1 having been fed in, a side stitching section 60 as a stitching device to stitch sheets S1 having been accumulated in the accumulating section 50 to give a bundle S2 thereof, a saddle stitching/folding device 80 to fold sheets S1 and to stitch the central portion thereof, a cover sheet storing section 90 to store additional sheets S4 such as cover sheets or interleaves, a sheet discharging tray 11 constituting an additional sheet discharging section to accumulate sheets S1 having been discharged from the image forming apparatus A, an elevating sheet discharging tray 12 constituting a sheet discharging section 20 to discharge and accumulate sheets S1 in large-volume image formation or a bundle S2 of sheets having been stitched, and a lower sheet discharging tray 13 to accumulate sheets S3 having been folded and saddle-stitched.

In the following description, a sheet S1 having been fed in from the image forming apparatus, a bundle S2 of sheets, and an additional sheet S4 are referred to as a sheet S1.

The punching device 30 incorporates a punching unit 31 housing a punching blade and a container 32 storing punched paper waste, and punches one or plural stitching holes in the edge of a sheet.

The shifting device 40 shifts the sheet discharging position with respect to the number of sheets each having been set The accumulating section 50 accumulates a sheet S1 to be stitched in the side stitching section 60 as a stitching device on an accumulation platform 51. The sheet S1 having been fed in the accumulating section 50 is conveyed in the left upward direction on the accumulating section 50 in the drawing. When having left a conveyance path H4, the sheet S1 is switched back for sliding on the accumulating platform 51 and then dropped right downward, followed by reaching the stopper (not shown) provided for the accumulating section 50 to be place in the accumulating section 50. Although not shown, the accumulating section 50 is provided with a matching mechanism to match a sheet S1. The side stitching section 60 punches a stitching needle at one or plural positions of the edge of a sheet S1 for stitching processing. The sheet 1 having been stitched in the side stitching section 60 is pushed up in the left upward direction of the drawing in the accumulating section 50 and conveyed to be discharged onto the elevating sheet discharging tray 12 provided for the sheet discharging section 20.

The saddle stitching/folding device 80 carries out center-folding of a sheet S1 at the central portion, saddle stitching to stitch the central portion with stitching needles, and folding processing for bi-folding or tri-folding.

In center-folding, a sheet S1 having been fed on a sheet support platform 81 is center-folded using a folding plate 82. In saddle stitching, sheets having been fed on the sheet support platform 81 are stitched in a stitching section 86. In bi-folding/tri-folding, sheets having been fed on the sheet support platform 81 are folded using the folding plate 82 and also subjected to folding processing using 3 folding rollers 83-85. The sheet S1 having been center-folded/saddle-stitched is discharged onto the lower sheet discharging tray 13.

Conveyance paths in the sheet post-processing apparatus B will now be described with reference to FIG. 3. In the sheet post-processing apparatus B, as conveyance paths to convey a sheet, H1-H8 are provided.

A straight conveyance path H1 is a conveyance path for a sheet conveyed from a sheet receiving section 10 to a sheet discharging section 20 in which an elevating sheet discharging tray 12 arranged, being linearly shaped as shown. An additional sheet conveyance path H2 is a conveyance path to send a sheet S1 from a cover sheet storing section 90 and joins a forward-leading conveyance path H3B of the conveyance path H3. The conveyance path H3 forms part of a conveyance path to convey a sheet S1 from the sheet receiving section 10 to the accumulating section 50. The conveyance path H3 is a loop-shaped conveyance path which is branched upward from the straight conveyance path H1 to then join the same, incorporating an upward-leading conveyance path H3A leading upward, a forward-leading conveyance path H3B to convey a sheet S1 in the direction leading from the sheet receiving section 10 to the sheet discharging section 20, a downward-leading conveyance path H3C to convey a sheet S1 from the forward-leading conveyance path H3B downward, and a backward-leading conveyance path H3D to convey a sheet S1 from the downward-leading conveyance path H3B in the direction leading from the sheet discharging section 20 to the sheet receiving section 10. For the backward-leading conveyance path H3D, the straight conveyance path H1 is shared. Herein, the straight conveyance path H1 conveys a sheet S1 from the sheet receiving section 10 toward the sheet discharging section 20. In contrast, the backward-leading conveyance path H3D conveys a sheet S1 in the direction leading from the sheet discharging section 20 to the sheet receiving section 10. A conveyance path H4 also forms part of a conveyance path for conveyance from the sheet receiving section 10 to the accumulating section 50. A conveyance path H5 is a conveyance path for a sheet S1 conveyed from the conveyance path H3 to a saddle stitching/folding device 80. H6 is a conveyance path for a sheet discharged from the saddle stitching/folding device 80 onto a lower sheet discharging tray 13. H7 is a conveyance path for a sheet S1 discharged from the conveyance path H3 onto a sheet discharging tray 11. H8 is a conveyance path as a queuing path to allow a sheet S1 to queue.

In continuous conveyance of a sheet S1, when the rear end of a sheet S1 having been conveyed through the downward-leading conveyance path H3C and the backward-leading conveyance path H3D has just passed the backward-leading conveyance path H3D, the moving direction of the sheet is reversed to move to the conveyance path H8. In the state where a foregoing sheet S1 is in queue in the conveyance path H8, a next sheet S1 is conveyed through the downward-leading conveyance path H3C and the backward-leading conveyance path H3D. At the position when the backward-leading conveyance path H3D and the conveyance path H8 are joined together, the foregoing sheet S1 and the following sheet S1 are joined and then a set of the two sheets is conveyed. Herein, at least 2 or plural sheets S1 can be accumulated and then conveyed using the conveyance path H8.

The processing time in the accumulating section 50 and the side stitching section 60 becomes longer than the discharging interval of a sheet S1 from the image forming apparatus A in some cases. The above sheet conveyance using the conveyance path H8 is used to adjust such a time difference.

Herein, a queuing path such as the conveyance path H8 can also be provided for the conveyance path H4 similarly to a conveyance path H9 shown with a dashed line. Part of the conveyance path H9 shown with a dashed line is common to the conveyance path H5. A sheet S1 having been fed in the conveyance path H5 is queued in the conveyance path H5 and then synchronized with the movement of a following sheet S1 having been conveyed through the conveyance path H4, followed by switch-back conveyance through the conveyance path H9 shown with a dashed line to be sent to the accumulating section 50.

By comparison of the sheet post-processing apparatus of the embodiments of the present invention shown in FIGS. 2 and 3 with the sheet post-processing apparatus of Unexamined Japanese Patent Application Publication No. 2002-308521 shown in FIG. 4, the relationship among the conveyance paths, the punching device, and the accumulating section in the sheet post-processing apparatus will now be described.

In Unexamined Japanese Patent Application Publication No. 2002-308521, as shown in FIG. 4, a punching member 40 is arranged in a linear conveyance path leading from the sheet receiving section to the sheet discharging section of the sheet post-processing apparatus (refer to FIG. 2 of Unexamined Japanese Patent Application Publication No. 2002-308521). On the other hand, an intermediate stacker 71 equivalent to the accumulating section is arranged inclined below the linear conveyance path. A sheet having left the punching member 40 is conveyed left in the drawing, namely, in the direction leading from the sheet receiving section to the sheet discharging section, and thereafter the moving direction is reversed, followed by moving to the direction leading from the sheet discharging section to the sheet receiving section. Further, the moving direction is reversed, followed by moving to the direction leading from the sheet receiving section to the sheet discharging section and then the sheet is placed on the intermediate stacker 71. On the intermediate stacker 71, the sheet is slid and dropped in the direction leading from the sheet discharging section to the sheet receiving section to be placed at a predetermined position on the intermediate stacker 71.

In this manner, a sheet having left the punching member 40 is passed through the S-shaped conveyance path shown with a thick line and then placed on the intermediate stacker 71.

In Unexamined Japanese Patent Application Publication No. 2002-308521, the conveyance path after the punching member 40 is formed in S shape, whereby to ensure a length required for sheet conveyance and a curvature radius required for sheet conveyance as the conveyance path between the punching member 40 and the intermediate stacker 71, a long conveyance path is formed in the vertical direction.

As a result, the slope of the intermediate stacker 71 becomes steep. Namely, the intermediate stacker 71 is arranged at a large inclined angle with respect to the horizon. Even if the inclined angle of the intermediate stacker 71 is intended to be small with respect to the horizon, the inclined angle cannot be reduced since the intermediate stacker 71, the conveyance path in the upstream of the intermediate stacker 71, and the punching member 40, specifically the punched paper waste container of the punching member exist.

In contrast, in the sheet post-processing apparatus shown in FIGS. 2 and 3, the conveyance path H3 is present immediately in the downstream of the sheet receiving section 10, and the punching device 30 is arranged in the conveyance path H3. As the conveyance path leading from the sheet receiving section 10 to the accumulating section 50, an S-shaped conveyance path is required. In the sheet post-processing apparatus of the present invention shown in FIGS. 2 and 3, an S-shaped conveyance path is formed by the conveyance path H3 and the conveyance path H4. Incidentally, the shape shown in S shape contains an upper loop and a lower loop. The upper loop is formed by the conveyance path H3 and the lower loop is formed by the conveyance path H4. Then, the punching device 30 is arranged in the upper loop of the S-shaped conveyance path, namely, in the conveyance path H3. In the example shown, the punching device 30 is arranged in the forward-leading conveyance path H3B of the conveyance path H3.

Via such an arrangement of the punching device 30, the accumulating section 50 and the upstream conveyance path of the accumulating section 50, namely, the lower loop (the conveyance path H4) of the S-shaped conveyance path can be arranged below the punching device 30.

In the arrangement of Unexamined Japanese Patent Application Publication No. 2002-308521, the punching member 40 is arranged outside the S-shaped conveyance path. In contrast, in FIGS. 2 and 3, the punching device 30 is arranged within the S-shaped conveyance path.

In FIG. 3, the arrangement relationship among the punching device 30, the S-shaped conveyance path, and the accumulating section 50 is clearly shown. Namely, the punching device 30 is arranged in the upper loop (the conveyance path H3) of the S-shaped conveyance path, and the lower loop (the conveyance path H4) of the S-shaped conveyance path is arranged below the conveyance path H3. The accumulating section 50 and the side stitching section 60 are arranged below the lower loop (the conveyance path H4) of the S-shaped conveyance path.

Such an arrangement makes it possible to arrange the accumulating section 50 at a desirable inclined angel. In addition, the width of the sheet post-processing apparatus B can be reduced.

In cases where a sheet S1 is accumulated in the accumulating section 50, when the angel of the accumulating section 50 with respect to the horizon is large, namely, nearly perpendicular, the flatness of thin paper is not maintained in the accumulating section 50, resulting in being curved. Thereby, the matching performance for a sheet S1 in the accumulating section 50 is decreased. To improve the matching performance, the angle of the accumulating section 50 with respect to the horizon is desirably allowed to fall in a range of 50±10°.

As shown in FIGS. 2 and 3, the punching device 30 was arranged in the upper loop of the S-shaped conveyance path, whereby the angle of the accumulating section with respect to the horizon was able to be allowed to fall in a range of 50±10° with no increase of the width of the sheet post-processing apparatus B.

In a non-stitching mode, a sheet S1 is nearly horizontally conveyed through the linear, straight conveyance path H1 from the sheet receiving section 10 or conveyed through the conveyance path H3 to be discharged onto the elevating sheet discharging stay 12. In a non-punching mode, a sheet S1 is passed through the straight conveyance path H1 and discharged onto the elevating sheet discharging tray 12. Further, in a punching mode, a sheet S1 is passed through the straight conveyance path H1 from the conveyance path H3 and discharged onto the elevating sheet discharging tray 12.

The sheet discharging tray 11 is used for printing of a small number of sheets or trial printing. In such a mode, a sheet S1 is passed through the conveyance path H3 and the additional sheet discharging path H7 from the sheet receiving section 10 and then discharged onto the sheet discharging tray 11.

In a saddle stitching, a center-folding, and a tri-folding mode, a sheet S1 is passed through part of the conveyance paths H3 and H4 and the conveyance path H5 from the sheet receiving section 10 and conveyed to the saddle stitching/folding device 80, followed by processing therein to be discharged onto the lower sheet discharging tray 13 via the conveyance path H6.

What is claimed is:

1. A sheet post-processing apparatus comprising,
a sheet receiving section to receive sheets,
a punching device to punch sheets;
an accumulating section to accumulate sheets;
a stitching device to stitch the sheets accumulated in the accumulating section;
a sheet discharging section to which the sheets stitched by the stitching device are discharged; and
a conveyance path to connect the sheet receiving section, the punching device, the accumulating section, and the sheet discharging section,
wherein the conveyance path comprises an upper loop and a lower loop and has an S-shaped conveyance path to convey a sheet from the sheet receiving section to the accumulating section; and
the punching device is arranged in the upper loop.

2. The sheet post-processing apparatus of claim 1,
wherein the conveyance path has a straight conveyance path to convey a sheet from the sheet receiving section to the sheet discharging section; and
the upper loop is branched upward from the straight conveyance path.

3. The sheet post-processing apparatus of claim 1,
wherein the upper loop comprises an upward-leading conveyance path, a forward-leading conveyance path, a downward-leading conveyance path, and a backward-leading conveyance path; and
the punching device is arranged in the forward-leading conveyance path.

4. The sheet post-processing apparatus of claim 1,
wherein a queuing path to queue a sheet is provided in the upper loop for collective conveyance of a plurality of sheets.

5. The sheet post-processing apparatus of claim 1,
wherein a queuing path to queue a sheet is provided in the lower loop for collective conveyance of a plurality of sheets.

6. The sheet post-processing apparatus of claim 1 further comprising an additional sheet conveyance path, wherein the additional sheet conveyance path joins the upper loop.

7. The sheet post-processing apparatus of claim 1 further comprising a saddle stitching/folding device arranged below the accumulating section; and
a conveyance path, branched from the lower loop, to convey a sheet to the saddle stitching/folding device.

8. The sheet post-processing apparatus of claim 1 further comprising an additional sheet discharging section; and
a sheet conveyance path branched from the upper loop and to convey a sheet to be discharged to the additional sheet discharging section.

9. The sheet post-processing apparatus of claim 1,
wherein the accumulating section is arranged at an angle falling in a range of 50±10° with respect to the horizon.

10. An image forming system comprising;
an image forming apparatus to form an image on a sheet; and
the sheet post-processing apparatus of claim 1 to receive and process a sheet discharged from the image forming apparatus.
